(19) United States
(12) Patent Application Publication
(10) Pub. No.: US 2018/0151965 A1
(43) Pub. Date: May 31, 2018

(54) CONNECTOR TERMINAL

(71) Applicant: Hosiden Corporation, Osaka (JP)

(72) Inventors: Hayato Kondo, Osaka (JP); Masakazu Yamazaki, Osaka (JP)

(21) Appl. No.: 15/814,921

(22) Filed: Nov. 16, 2017

(30) Foreign Application Priority Data
Nov. 25, 2016 (JP) 2016-229242

(51) Int. Cl. H01R 4/60; H01R 4/18; H01R 4/48

(52) U.S. Cl. CPC H01R 4/60; H01R 4/4818; H01R 4/184

(57) ABSTRACT

A connector terminal is provided which has a first connecting portion that is tubular, in one side, and a second connecting portion in the other side, which further has a coupling portion that couples between the first and second connecting portions, and that is higher in impedance than the first connecting portion, and in which the trouble of providing impedance matching between the first connecting portion and the coupling portion is reduced. The connector terminal includes an impedance adjusting member that overlaps at least a first side part of the coupling portion. The impedance adjusting member is fixed in a state where one end portion of the impedance adjusting member is inserted into the body portion.

### TECHNICAL FIELD

The present invention relates to a connector terminal which has a first connecting portion that is tubular, in one side, and a second connecting portion in the other side, which further has a coupling portion that couples between the first and second connecting portions, and that is higher in impedance than the first connecting portion, and in which impedance matching between the first connecting portion and the coupling portion is provided.

### BACKGROUND ART

In high-speed transmission or high-frequency transmission, in order to perform high-quality transmission, it is requested to match impedances also in a connector terminal.

Patent Literature 1 discloses a connector terminal that has a tubular body portion which is to be connected to a counter connector terminal, in one side, and a crimp portion in which a crimp piece to which a cable conductor is to be crimped is disposed, in the other side, and that further has a coupling portion (a portion which is in the crimp portion, and in which the crimp piece is not disposed) which is higher in impedance than the body portion. In a state where one end is inserted into the body portion, and the other end is joined to the crimp portion, the cross-sectional outer shape of the coupling portion is increased by an impedance adjusting member which overlaps the coupling portion, so as to coincide with the cross-sectional outer shape of the body portion, thereby providing impedance matching between the body portion and the coupling portion.

### PRIOR ART LITERATURE

### Patent Literature

Patent Literature 1: Japanese Patent No. 5,332,677

### SUMMARY OF THE INVENTION

### Problems to be Solved by the Invention

In the connector terminal disclosed by Patent Literature 1, however, the impedance adjusting member must be coupled to the crimp portion, and therefore it is cumbersome to provide impedance matching between the body portion and the coupling portion.

It is an object of the invention to provide a connector terminal which has a first connecting portion that is tubular, in one side, and a second connecting portion in the other side, which further has a coupling portion that couples between the first and second connecting portions, and that is higher in impedance than the first connecting portion, and in which the trouble of providing impedance matching between the first connecting portion and the coupling portion is reduced.

### Means for Solving the Problems

(1) The present invention is a connector terminal which has a first connecting portion that is tubular, in one side, and a second connecting portion in another side, and which further has a coupling portion that couples between the first and second connecting portions, and that is higher in impedance than the first connecting portion, wherein the connector terminal comprises an impedance adjusting member which overlaps at least a part of the coupling portion, and the impedance adjusting member is fixed in a state where one end portion of the impedance adjusting member is inserted into the first connecting portion.

According to the connector terminal of (1) above, impedance matching between the first connecting portion and the coupling portion can be provided simply by inserting the one end portion of the impedance adjusting member into the first connecting portion. It is not necessary to couple the impedance adjusting member to the second connecting portion. Therefore, the trouble of providing impedance matching between the first connecting portion and the coupling portion is reduced.

(2) The connector terminal according to (1) above has another future wherein the coupling portion is configured by a strip-like piece which is bent into an L-like shape, has first and second side parts which form sides of the L-like shape, respectively, is connected to the first connecting portion in an end of the first side part, and connected to the second connecting portion in an end of the second side part, and the impedance adjusting member overlaps at least the first side part.

According to the connector terminal of (2) above, the coupling portion is bent into an L-like shape, and therefore the second connecting portion does not interfere with the insertion of the one end portion of the impedance adjusting member into the first connecting portion, so that the insertion can be easily performed.

(3) The connector terminal according to (1) or (2) above has a further feature wherein a tapered tip end is formed in the one end portion of the impedance adjusting member.

According to the connector terminal of (3) above, the tapered tip end is formed in the one end portion of the impedance adjusting member, and therefore, when the one end portion of the impedance adjusting member is to inserted into the first connecting portion, the insertion can be easily performed.

(4) The connector terminal according to any one of (1) to (3) above has a still further feature wherein the one end portion of the impedance adjusting member is thicker than an inner diameter of the first connecting portion, thereby forming the one end portion as a press-fitting part which is inserted into the first connecting portion.

According to the connector terminal of (4) above, the one end portion of the impedance adjusting member can be fixed to the first connecting portion by press-fitting.

### Effects of the Invention

According the invention, it is possible to provide a connector terminal which has a first connecting portion that is tubular, in one side, and a second connecting portion in the other side, which further has a coupling portion that couples between the first and second connecting portions, and that is higher in impedance than the first connecting portion, and in which the trouble of providing impedance matching between the first connecting portion and the coupling portion is reduced.

### BRIEF DESCRIPTION OF THE DRAWINGS

FIG. 1 is an exploded perspective view showing a connector terminal of an embodiment of the invention.

FIG. 2 is a perspective view showing the connector terminal of the embodiment of the invention.

FIG. 3 is a sectional view showing the connector terminal of the embodiment of the invention.

FIG. 4 is a sectional view of main components of a connector terminal of another embodiment of the invention.

FIG. 5A is a perspective view showing an impedance adjusting member of a connector terminal of a further embodiment of the invention, and FIG. 5B is a back view of the member.

### DESCRIPTION OF PREFERRED EMBODIMENTS

Hereinafter, several embodiments of the invention will be described with reference to the drawings.

### Embodiment 1

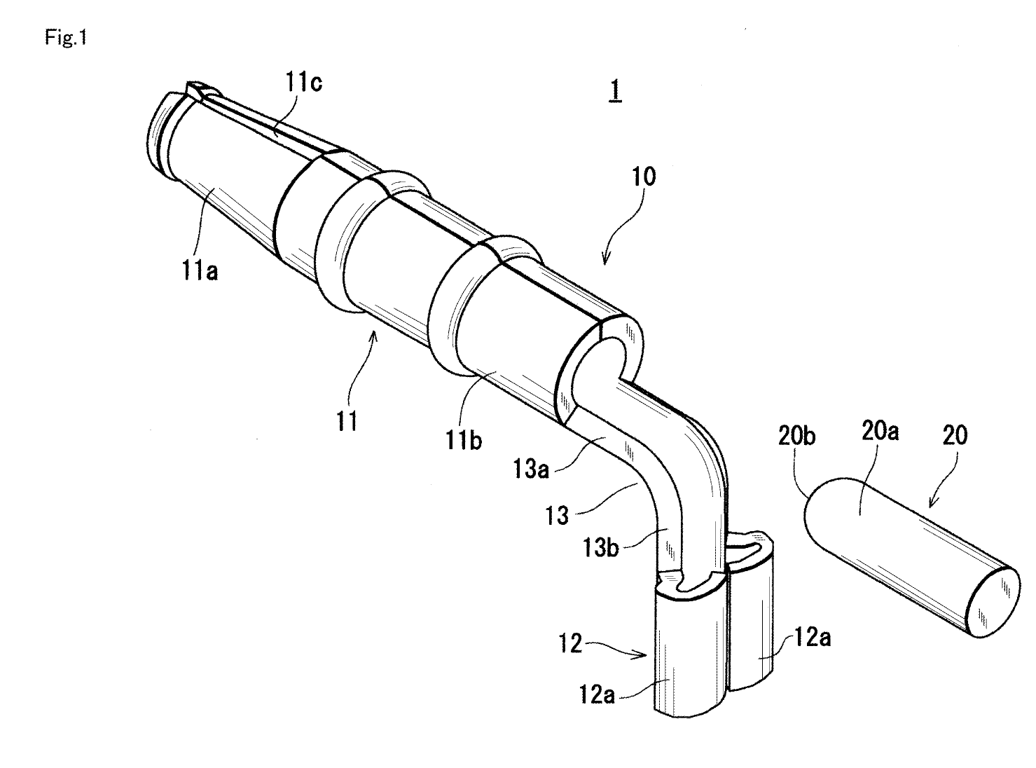

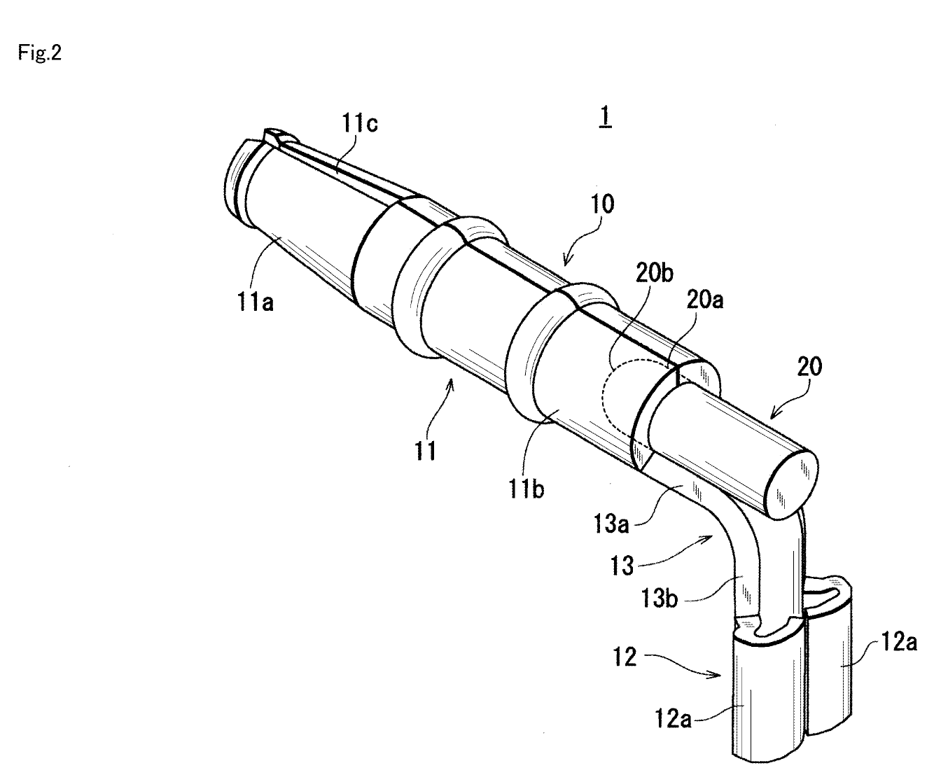

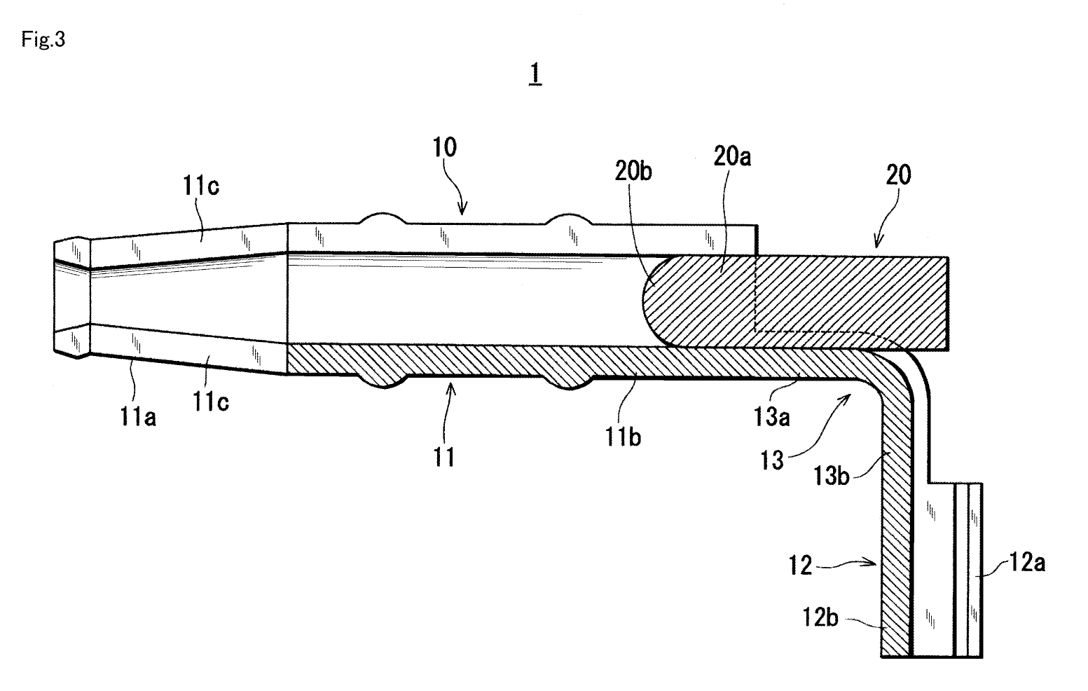

A connector terminal 1 shown in FIGS. 1 to 3 comprises a terminal body 10 and an impedance adjusting member 20.

The terminal body 10 has: in one side, a tubular (female) body portion 11 which functions as the first connecting portion that is tubular, and which is to be connected to a pin-like (male) counter connector terminal that is not shown; and, in the other side, a crimp portion 12 which functions as the second connecting portion, and which is to be connected to a cable conductor that is not shown. The terminal body 10 further has a coupling portion 13 that couples between the body portion 11 and the crimp portion 12. The terminal body 10 is formed by pressing an electrically conductive metal thin plate.

The body portion 11 has a tip end portion 11a and a basal portion 11b. In the tip end portion 11a, a plurality (two in the figures) of slits 11c which extend in the axial direction are disposed at regular intervals in the circumferential direction, and the connection with the counter connector terminal is performed by using the slits 11c. The basal portion 11b which is continuous to the tip end portion 11a is formed into a cylindrical shape.

The crimp portion 12 which has not yet been connected to the cable conductor is formed to have a U-like sectional shape, and has: a pair of crimp pieces 12a which form the opposed lateral sides of the U-like shape, respectively; and a basal portion 12b which forms the bottom side of the U-like shape. The crimp portion 12 can be connected to the cable conductor by, as illustrated, crimping the pair of crimp pieces 12a in the state where the cable conductor is fitted.

The coupling portion 13 is configured by a strip-like piece which is thinner than the outer diameter of the basal portion 11b of the body portion 11, and which is bent into an L-like shape, has first and second side parts 13a, 13b which form sides of the L-like shape, respectively, is connected to an end (end face) of the basal portion 11b of the body portion 11 in an end (end face) of the first side part 13a, and connected to an end (end face) of the basal portion 12b of the crimp portion 12 in an end (end face) of the second side part 13b.

The impedance adjusting member 20 is a metal member having a round bar-like shape which is longer than the first side part 13a of the coupling portion 13 of the terminal body 10, and which is thicker than the inner diameter of the basal portion 11b of the body portion 11 of the terminal body 10. The impedance adjusting member 20 is electrically conductive. A tapered tip end 20b which is semi-spherical is formed in one end portion 20a of the impedance adjusting member 20.

Then, the impedance adjusting member 20 is fixed to the basal portion 11b of the body portion 11 of the terminal body 10 in a state where the one end portion 20a in which the tapered tip end 20b is formed is inserted into the basal portion 11b of the body portion 11 of the terminal body 10 through an end opening of the basal portion 11b, and the part other than the one end portion 20a in which the tapered tip end 20b is formed overlaps the first side part 13a of the coupling portion 13 of the terminal body 10. In this state, the impedance adjusting member 20 is electrically connected to the terminal body 10. Here, the one end portion 20a in which the tapered tip end 20b of the impedance adjusting member 20 is formed is thicker than the inner diameter of the basal portion 11b of the body portion 11 of the terminal body 10, and configured as a press-fitting part with respect to the basal portion 11b of the body portion 11 of the terminal body 10.

Next, the function of the thus configured connector terminal 1 will be described.

In the terminal body 10, the cross-sectional outer shape of the body portion 11 and that of the crimp portion 12 are substantially identical in size with each other, and therefore the impedance of the body portion 11 is approximately equal to that of the crimp portion 12. By contrast, the cross-sectional outer shape of the coupling portion 13 is smaller than both the cross-sectional outer shapes of the body portion 11 and the crimp portion 12, and therefore the impedance of the coupling portion 13 is higher than both the impedances of the body portion 11 and the crimp portion 12. As a result, impedance mismatching is caused between the body portion 11 and the coupling portion 13 and also between the crimp portion 12 and the coupling portion 13.

In the impedance adjusting member 20, the part other than the one end portion 20a overlaps the first side part 13a of the coupling portion 13 of the terminal body 10. In the part other than the one end portion 20a, the cross-sectional outer shape of the first side part 13a of the coupling portion 13 of the terminal body 10 is increased, and the impedance of the coupling portion 13 of the terminal body 10 can be lowered. Therefore, the impedance mismatching between the body portion 11 of the terminal body 10 and the coupling portion 13 can be reduced, and impedance matching between the body portion 11 of the terminal body 10 and the coupling portion 13 can be attained.

In this case, the impedance adjusting member 20 is fixed to the basal portion 11b of the body portion 11 of the terminal body 10 in the state where the one end portion 20a of the impedance adjusting member is inserted into the basal portion 11b of the body portion 11 of the terminal body 10 through the end opening of the basal portion 11b, whereby the part other than the one end portion 20a is caused to overlap the first side part 13a of the coupling portion 13 of the terminal body 10. Therefore, impedance matching can be provided between the body portion 11 of the terminal body 10 and the coupling portion 13, simply by inserting the one end portion 20a of the impedance adjusting member 20 into the basal portion 11b of the body portion 11 of the terminal body 10 through the end opening of the basal portion 11b, and it is not necessary to couple the impedance adjusting member 20 to the crimp portion 12 of the terminal body 10. Consequently, the trouble of providing impedance matching between the body portion 11 of the terminal body 10 and the coupling portion 13 can be reduced.

Moreover, the coupling portion 13 of the terminal body 10 is bent into an L-like shape, and therefore the crimp portion 12 does not interfere with the insertion of the one end portion 20a of the impedance adjusting member 20 into the basal portion 11b of the body portion 11 of the terminal body 10 through the end opening of the basal portion 11b, and the insertion can be easily performed. Furthermore, the tapered tip end 20b is formed in the one end portion 20a of the impedance adjusting member 20. When the one end portion 20a of the impedance adjusting member 20 is to be inserted into the basal portion 11b of the body portion 11 of the terminal body 10 through the end opening of the basal portion 11b, therefore, the insertion can be easily performed.

Moreover, the one end portion 20a of the impedance adjusting member 20 is thicker than the inner diameter of the basal portion 11b of the body portion 11 of the terminal body 10, and configured as the press-fitting part with respect to the basal portion 11b of the body portion 11 of the terminal body 10. Therefore, the one end portion 20a can be press-fitted into the basal portion 11b of the body portion 11 of the terminal body 10.

In the impedance adjusting member 20, impedance matching between the body portion 11 of the terminal body 10 and the coupling portion 13 can be provided, and at the same time also that between the crimp portion 12 of the terminal body 10 and the coupling portion 13 can be provided.

### Embodiment 2

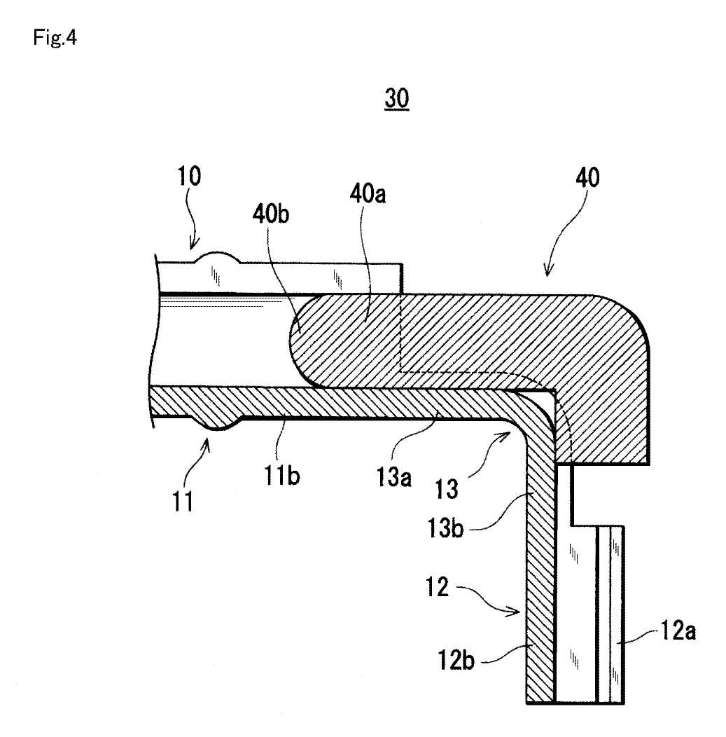

A connector terminal 30 shown in FIG. 4 is different from the connector terminal 1 in that the connector terminal 30 comprises an impedance adjusting member 40 which is bent into an L-like shape, in place of the impedance adjusting member 20.

The impedance adjusting member 40 which is bent into an L-like shape is different from the impedance adjusting member 20 in that a part other than one end portion 40a in which a tapered tip end 40b is formed overlaps the first and second side parts 13a, 13b of the coupling portion 13 of the terminal body 10.

The impedance adjusting member 40 which is bent into an L-like shape is fixed to the basal portion 11b of the body portion 11 of the terminal body 10 in the state where the one end portion 40a of the impedance adjusting member is inserted into the basal portion 11b of the body portion 11 of the terminal body 10 through the end opening of the basal portion 11b, whereby the part other than the one end portion 40a is caused to overlap the first and second side parts 13a, 13b of the coupling portion 13 of the terminal body 10. The impedance of the coupling portion 13 of the terminal body 10 can be lowered by increasing the cross-sectional outer shapes of the first and second side parts 13a, 13b of the coupling portion 13 of the terminal body 10 in the part other than the one end portion 40a. The impedance mismatching between the body portion 11 of the terminal body 10 and the coupling portion 13 can be substantially resolved, and impedance matching between the body portion 11 of the terminal body 10 and the coupling portion 13, and that between the crimp portion 12 of the terminal body 10 and the coupling portion 13 can be attained.

### Embodiment 3

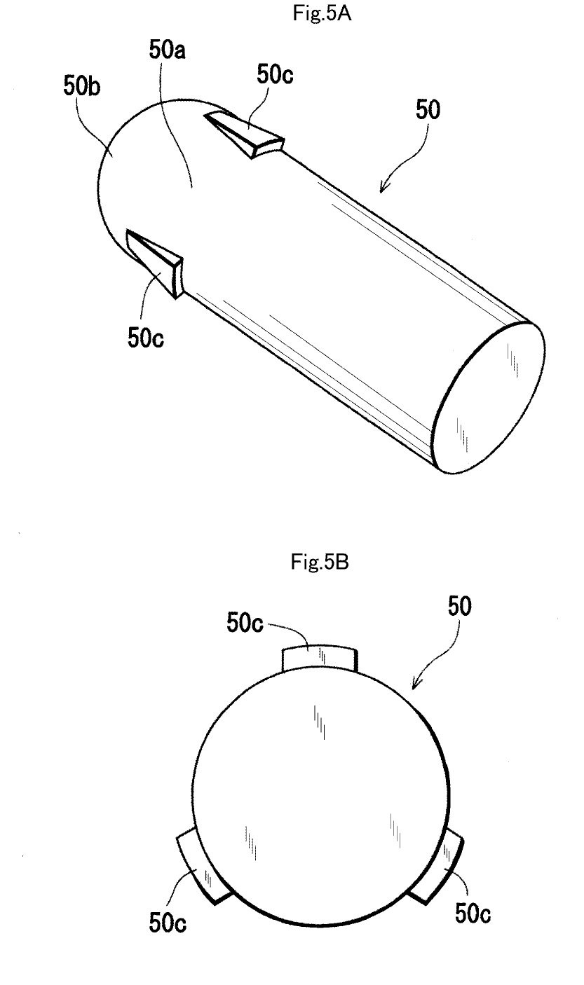

An impedance adjusting member 50 having wedges shown in FIGS. 5A and 5B is different from the impedance adjusting member 20 in that the impedance adjusting member 50 has a round bar-like shape in which the diameter is approximately equal to the inner diameter of the basal portion 11b of the body portion 11 of the terminal body 10, three wedges 50c are disposed at regular intervals on the outer circumferential surface of one end portion 50a in which a tapered tip end 50b is formed, and the outer diameter of the one end portion 50a in which a tapered tip end 50b is formed is gradually increased by the wedges 50c as advancing toward the side opposite to the side of the tip end 50b.

Then, the impedance adjusting member 50 having the wedges is fixed to the basal portion 11b of the body portion 11 of the terminal body 10 in the state where the one end portion 50a in which the tapered tip end 50b is formed, and in which the wedges 50c are disposed on the outer circumferential surface is press-fitted into the basal portion 11b of the body portion 11 of the terminal body 10 through the end opening of the basal portion 11b, whereby the part other than the one end portion 50a is caused to overlap the first side part 13a of the coupling portion 13 of the terminal body 10. The impedance matching between the body portion 11 of the terminal body 10 and the coupling portion 13 can be attained.

Although several embodiments of the invention have been described with reference to the drawings, the invention is not limited to the embodiments, and may be variously modified without departing the spirit of the invention. Although a round bar-like member having a circular section has been used as the impedance adjusting member, for example, the impedance adjusting member may be a polygonal bar having a polygonal section. As the method of fixing the impedance adjusting member in the state where the one end portion is inserted into the basal portion of the body portion of the terminal body, press-fitting has been employed. Alternatively, other engaging means may be employed such as those in which one of a pair of engaging concave and convex parts that are engageable with each other when the impedance adjusting member (shaft) is inserted into the body portion (hole) of the terminal body is disposed in the impedance adjusting member, and the other part is disposed in the basal portion of the body portion of the terminal body.

### DESCRIPTION OF REFERENCE NUMERALS

1 connector terminal
10 terminal body
20 impedance adjusting member
20a one end portion
20b tip end
11 body portion (first connecting portion)
12 crimp portion (second connecting portion)
13 coupling portion
13a first side part
13b second side part

What is claimed is:

1. A connector terminal which has a first connecting portion that is tubular, in one side, and a second connecting portion in another side, and which further has a coupling portion that couples between the first and second connecting portions, and that is higher in impedance than the first connecting portion, wherein the connector terminal comprises an impedance adjusting member which overlaps at least a part of the coupling portion, and the impedance adjusting member is fixed in a state where one end portion of the impedance adjusting member is inserted into the first connecting portion.

2. The connector terminal according to claim 1, wherein the coupling portion is configured by a strip-like piece which is bent into an L-like shape, has first and second side parts which form sides of the L-like shape, respectively, is connected to the first connecting portion in an end of the first side part, and connected to the second connecting portion in an end of the second side part, and the impedance adjusting member overlaps at least the first side part.

3. The connector terminal according to claim 1, wherein a tapered tip end is formed in the one end portion of the impedance adjusting member.

4. The connector terminal according to claim 1, wherein the one end portion of the impedance adjusting member is thicker than an inner diameter of the first connecting portion, thereby forming the one end portion as a press-fitting part which is inserted into the first connecting portion.

5. The connector terminal according to claim 1, wherein the coupling portion is configured by a strip-like piece which is bent into an L-like shape, has first and second side parts which form sides of the L-like shape, respectively, is connected to the first connecting portion in an end of the first side part, and connected to the second connecting portion in an end of the second side part, the impedance adjusting member overlaps at least the first side part, and a tapered tip end is formed in the one end portion of the impedance adjusting member.

6. The connector terminal according to claim 1, wherein the coupling portion is configured by a strip-like piece which is bent into an L-like shape, has first and second side parts which form sides of the L-like shape, respectively, is connected to the first connecting portion in an end of the first side part, and connected to the second connecting portion in an end of the second side part, the impedance adjusting member overlaps at least the first side part, and the one end portion of the impedance adjusting member is thicker than an inner diameter of the first connecting portion, thereby forming the one end portion as a press-fitting part which is inserted into the first connecting portion.

7. The connector terminal according to claim 1, wherein the coupling portion is configured by a strip-like piece which is bent into an L-like shape, has first and second side parts which form sides of the L-like shape, respectively, is connected to the first connecting portion in an end of the first side part, and connected to the second connecting portion in an end of the second side part, the impedance adjusting member overlaps at least the first side part, a tapered tip end is formed in the one end portion of the impedance adjusting member, and the one end portion of the impedance adjusting member is thicker than an inner diameter of the first connecting portion, thereby forming the one end portion as a press-fitting part which is inserted into the first connecting portion.
